(19) United States
(12) Patent Application Publication
(10) Pub. No.: US 2026/0275873 A1
(43) Pub. Date: Sep. 17, 2026

(54) TIAL ALLOY MATERIAL AND TURBINE BLADE FOR JET ENGINES

(71) Applicants: NATIONAL INSTITUTE FOR MATERIALS SCIENCE, Tsukuba-shi (JP); AEROEDGE CO., LTD., Ashikaga-shi (JP)

(72) Inventors: Toshimitsu TETSUI, Tsukuba-shi (JP); Kazuhiro MIZUTA, Ashikaga-shi (JP); Takayuki IMOTO, Ashikaga-shi (JP); Hirokazu TANAKA, Ashikaga-shi (JP)

(73) Assignees: NATIONAL INSTITUTE FOR MATERIALS SCIENCE, Tsukuba-shi (JP); AEROEDGE CO., LTD., Ashikaga-shi (JP)

(21) Appl. No.: 19/469,124

(22) PCT Filed: Feb. 15, 2024
(86) PCT No.: PCT/JP2024/005329

§ 371 Date: Sep. 25, 2025

(30) Foreign Application Priority Data
Mar. 27, 2023 (JP) 2023-049763

(51) Int. Cl. F01D 5/28; C22C 1/02; C22C 14/00

(52) U.S. Cl. CPC F01D 5/28; C22C 1/02; C22C 14/00; F05D 2300/174

(57) ABSTRACT

A TiAl alloy material contains aluminum: 45.5 to 47.5 atom %, manganese: 1.0 to 3.0 atom %, iron: 0.3 to 1.0 atom %, vanadium: 0.5 to 2.0 atom %, and niobium: 0.5 to 2.5 atom %, with a remainder being made up of titanium and unavoidable impurities. The TiAl alloy material may further contain carbon: 0.6 atom % or less.

### TECHNICAL FIELD

The present invention relates to a TiAl alloy material and a turbine blade for jet engines.

Priority is claimed on Japanese Patent Application No. 2023-049763, filed Mar. 27, 2023, the content of which is incorporated herein by reference.

### BACKGROUND ART

Conventionally, turbine blades for jet engines, which are made of Ni-based superalloys, have been used. In recent years, turbine blades for jet engines, which are made of TiAl alloys, have been used. The density of TiAl alloys is about ½ that of Ni-based superalloys. Therefore, turbine blades for jet engines, which are made of TiAl alloys, greatly contribute to improving engine efficiency and reducing fuel consumption by weight reduction.

Conventionally, there are two types of TiAl alloy materials that have been put into practical use as materials for turbine blades for jet engines. The first TiAl alloy material put into practical use was TiAl4822 (Ti-48.0Al-2Nb-2Cr (atom %)). TiAl4822 is currently used in a large amount as a material for the last stage turbine blade for jet engines such as Leading Edge Aviation Propulsion (LEAP). The next TiAl alloy material put into practical use was a TNM alloy (Ti-43.5Al-4.0Nb-1.0Mo-0.1B (atom %)).

Currently, turbine blades for jet engines, which are made of TiAl alloy materials, are produced by a machining method of cutting out a large rectangular ingot. Therefore, the turbine blades for jet engines, which are made of TiAl alloy materials, require a very large amount of machining during production, which results in high processing costs.

Therefore, it has been examined that a raw material having a shape close to that of a turbine blade for jet engines be produced using an investment casting method, and this be subjected to a small amount of machining method as necessary to produce a turbine blade for jet engines, which is made of a TiAl alloy material. In the investment casting method, a casting product is produced using a ceramic mold including a cavity portion having an inner shape close to the shape of the product. Then, the ceramic mold adhered to the outside of the casting product is removed. Thereby, a raw material made of the casting product having a shape close to the shape of the product is obtained. Therefore, when the investment casting method is used, it is possible to reduce the amount of machining and reduce the number of processing steps and the removal amount due to machining.

Patent Document 1 describes an investment casting method for Ti and Ti alloys. In addition, Patent Document 1 describes melting of Ti or a Ti alloy base by induction heating, and suction casting of the melted Ti, or Ti alloy mass into a gas permeable mold. In addition, Patent Document 1 discloses a TiAl intermetallic compound as Ti, or a Ti alloy base.

Patent Document 2 describes a centrifugal casting method for metallic materials. In addition, Patent Document 2 discloses a method in which a mold is placed on a rotating table, and a molten alloy is poured into the mold while the rotating table is rotating. In addition, Patent Document 2 discloses that the metallic material is a TiAl alloy, a Ti alloy or a Ni alloy.

Patent Document 3 describes a method of producing a Ti alloy casting product including filling a Ti alloy molten alloy into a cavity in a mold, rotating the mold at a high speed together with the internal molten alloy, and applying a centrifugal force to the molten alloy to perform casting. In addition. Patent Document 3 discloses that the Ti alloy is a Ti alloy based on a TiAl intermetallic compound.

### CITATION LIST

### Patent Document

Patent Document 1: Japanese Unexamined Patent Application, First Publication No. H4-22562 (A)
Patent Document 2: Japanese Unexamined Patent Application, First Publication No. 2016-78067 (A)
Patent Document 3: Japanese Unexamined Patent Application, First Publication No. 2008-254052 (A)

### SUMMARY OF INVENTION

### Technical Problem

However, in conventional TiAl alloy cast materials, the fluidity of the molten alloy obtained by melting raw materials corresponding to the composition after casting is insufficient, and the castability is insufficient. Therefore, for example, when a TiAl alloy cast material is produced by an investment casting method using raw materials corresponding to the composition of the TiAl alloy cast material, a defective shape due to poor molten alloy flowability caused by the formation of a region in the cavity portion of the mold where the molten alloy is not sufficiently filled in is likely to occur.

Particularly, when a turbine blade for jet engines, which is made of a TiAl alloy cast material, is produced by the investment casting method, poor formation due to poor molten alloy flowability is likely to occur, and the non-defective product yield is low. This is because the turbine blade for jet engines has a complex shape.

In addition, it is important for the turbine blade for jet engines to have good impact resistance. For example, a TNM alloy, which has been put into practical use as a material for turbine blades for jet engines, was once used as the material for the last stage turbine blade of the high bypass geared turbofan engine PW1100G, but its use was suddenly discontinued. It has been publicly reported that the reason for this was destruction of a considerable number of blades due to high-speed collision of debris scattering from the inside of the engine during flight with the last stage turbine blade made of the TNM alloy. That is, the impact resistance of the turbine blade for jet engines is an important property that determines whether it can be used continuously as a product. The impact resistance of the turbine blade for jet engines is determined according to the material for the turbine blade for jet engines.

In addition, since the turbine blade for jet engines is a member used at a high temperature, needless to say, it is necessary to have good high-temperature strength and oxidation resistance.

However, conventional TiAl alloy cast materials have good castability but do not have excellent properties in all respects, such as impact resistance, high-temperature strength, and oxidation resistance.

The present invention has been made in view of the above circumstances, and an object of the present invention is to provide a TiAl alloy material which has good castability and excellent impact resistance, high-temperature strength, and oxidation resistance and can be suitably used as a material for a turbine blade for jet engines.

In addition, an object of the present invention is to provide a turbine blade for jet engines, which is made of a TiAl alloy material, can be produced with a high yield, and has excellent impact resistance, high-temperature strength, and oxidation resistance.

### Solution to Problem

In order to achieve the above objects, the following aspects are provided.
[1] A TiAl alloy material, comprising
   aluminum: 45.5 to 47.5 atom %,
   manganese: 1.0 to 3.0 atom %,
   iron: 0.3 to 1.0 atom %,
   vanadium: 0.5 to 2.0 atom %, and
   niobium: 0.5 to 2.5 atom %,
   a titanium and unavoidable impurities balance containing inevitable impurities.
[2] The TiAl alloy material according to [1], further containing carbon: 0.6 atom % or less.
[3] The TiAl alloy material according to [2], further containing carbon: 0.2 atom % or more.
[4] The TiAl alloy material according to [1],
   wherein a content of aluminum is 46.0 to 47.0 atom %.
[5] The TiAl alloy material according to [1],
   wherein a content of manganese is 1.2 to 2.8 atom %.
[6] The TiAl alloy material according to [1],
   wherein a content of iron is 0.4 to 0.8 atom %.
[7] The TiAl alloy material according to [1],
   wherein a content of vanadium is 0.7 to 1.8 atom %.
[8] The TiAl alloy material according to [1],
   wherein a content of niobium is 0.6 to 2.3 atom %.
[9] The TiAl alloy material according to [3],
   wherein a content of carbon is 0.3 to 0.5 atom %.
[10] The TiAl alloy material according to [1],
   wherein, an amount of leaked molten alloy leaking from the slit is 20 g or more, in a case where 500 g of a molten alloy obtained by melting raw materials corresponding to a composition after casting is poured from a pouring gate, and
   wherein, in a mold having a rectangular cavity portion in a plan view, the cavity portion having a side extending in a first direction that is 80 mm in length and a side extending in a second direction that becomes shorter in length in a stepwise manner from the pouring gate to a bottom surface, and a slit is provided on the bottom surface, length of the slit in the first direction and the second direction is 80 mm and 1 mm, respectively.
[11] The TiAl alloy material according to [1],
   wherein the absorbed energy in a Charpy impact test at 20° C. is 4 J/cm² or more.
[12] The TiAl alloy material according to [1],
   wherein a tensile strength at 800° C. is 400 MPa or more.
[13] The TiAl alloy material according to [1],
   wherein a weight increase when the surface is polished with water-resistant abrasive paper having a grit size of 600 and then held at 1,000° C. for 100 hours in air is 0.2 kg/m² or less.
[14] A turbine blade for jet engines made of the TiAl alloy material according to any one of [1] to [13].

### Advantageous Effects of Invention

The TiAl alloy material of the present invention contains predetermined amounts of aluminum (Al), manganese (Mn), iron (Fe), vanadium (V), and niobium (Nb), with the remainder being made up of titanium (Ti) and unavoidable impurities. Therefore, the TiAl alloy material of the present invention has good castability. Therefore, the TiAl alloy material of the present invention can be produced with a high non-defective product yield using a casting method such as an investment casting method. Moreover, the TiAl alloy material of the present invention has excellent impact resistance, high-temperature strength, and oxidation resistance. Therefore, the TiAl alloy material of the present invention can be preferably used as a material for the turbine blade for jet engines.

In addition, since the turbine blade for jet engines of the present invention is made of a TiAl alloy material of the present invention, it can be produced with a high yield and has excellent impact resistance, high-temperature strength, and oxidation resistance.

### BRIEF DESCRIPTION OF DRAWINGS

FIG. 1A is a plan view of a mold used in an example.

FIG. 1B is a cross-sectional view of a mold used in an example.

FIG. 2 is an image of an example of a TiAl alloy cast material obtained in an example, and is a captured image of Alloy No. 2.

FIG. 3 is a diagram showing the shape of a tensile test piece used in evaluating high-temperature strength.

FIG. 4A is a captured image of a molten alloy leaking from a slit provided on a bottom surface of a cavity portion 11 from the outer surface of a mold 10 when a molten alloy is poured into the mold 10 in Alloy No. 6 (comparative alloy).

FIG. 4B is a captured image of a molten alloy leaking from a slit provided on a bottom surface of a cavity portion 11 from the outer surface of a mold 10 when a molten alloy is poured into the mold 10 in Alloy No. 8 (invention alloy).

### DESCRIPTION OF EMBODIMENTS

In order to achieve the above objects, the inventors conducted extensive studies focusing on the relationship between the composition of the TiAl alloy cast material, and the castability, impact resistance, high-temperature strength, and oxidation resistance.

As a result, they found that a TiAl alloy cast material containing aluminum (Al): 45.5 to 47.5 atom %, manganese (Mn): 1.0 to 3.0 atom %, iron (Fe): 0.3 to 1.0 atom %, vanadium (V): 0.5 to 2.0 atom %, and niobium (Nb): 0.5 to 2.5 atom %, with the remainder being made up of titanium (Ti) and unavoidable impurities, is sufficient.

More specifically, they found that, when the Al content contained in the TiAl alloy cast material is set to be within the above relatively narrow range, and Mn and Fe are then each incorporated within the above ranges to improve castability, V is incorporated within the above range to improve impact resistance, and Nb is incorporated within the above range to improve oxidation resistance, all properties including castability, impact resistance, high-temperature strength, and oxidation resistance thus become suitable for a material for a turbine blade for jet engines, and completed the present invention.

Hereinafter, a TiAl alloy material and a turbine blade for jet engines of the present invention will be described in detail. In the present embodiment, as an example of the TiAl alloy material of the present invention, a case in which the TiAl alloy material is a TiAl alloy cast material produced using a casting method will be exemplified.

[TiAl alloy cast material] The TiAl alloy cast material (TiAl alloy material) of the present embodiment contains aluminum (Al): 45.5 to 47.5 atom %, manganese (Mn): 1.0 to 3.0 atom %, iron (Fe): 0.3 to 1.0 atom %, vanadium (V): 0.5 to 2.0 atom %, and niobium (Nb): 0.5 to 2.5 atom %, with the remainder being made up of titanium and unavoidable impurities.

The TiAl alloy cast material of the present embodiment is a cast product produced by a casting method. As the casting method, for example, an investment casting method can be used.

### “Al”

Al is a basic element of a TiAl alloy together with Ti, Al, together with Ti, forms a TiAl phase, a Ti₃Al phase or the like in the TiAl alloy cast material. When the Al content is less than 45.5 atom %, the impact resistance becomes insufficient. In addition, when the Al content is more than 47.5 atom %, the high-temperature strength and the impact resistance become insufficient. Therefore, the Al content in the TiAl alloy cast material is 45.5 to 47.5 atom %. The Al content is preferably 46.0 to 47.0 atom % and more preferably 46.2 to 46.8 atom % in order to secure the impact resistance and secure the high-temperature strength and the oxidation resistance.

### “Mn”

Mn improves the castability when the Al content contained in the TiAl alloy cast material is within the above range. When the Mn content is less than 1.0 atom %, an effect of improving the castability is not sufficiently obtained. In addition, when the Mn content is more than 3.0 atom %, the high-temperature strength and the oxidation resistance become insufficient. Therefore, the amount of Mn added to the TiAl alloy cast material is 1.0 to 3.0 atom %. In order to improve the castability and in order to secure the high-temperature strength and the oxidation resistance, the Mn content is preferably 1.2 to 2.8 atom % and more preferably 1.5 to 2.5 atom %.

### “Fe”

Fe improves the castability when the Al content contained in the TiAl alloy cast material is within the above range. When the Fe content is less than 0.3 atom %, an effect of improving the castability is not sufficiently obtained. In addition, when the Fe content is more than 1.0 atom %, the high-temperature strength and the oxidation resistance become insufficient. Therefore, the Fe content in TiAl alloy cast material is 0.3 to 1.0 atom %. In order to improve the castability and in order to secure the high-temperature strength and the oxidation resistance, the Fe content is preferably 0.4 to 0.8 atom % and more preferably 0.5 to 0.7 atom %.

### “V”

V improves the impact resistance when the Al content contained in the TiAl alloy cast material is within the above range. When the V content is less than 0.5 atom %, an effect of improving the impact resistance is not sufficiently obtained. In addition, when the V content is more than 2.0 atom %, the oxidation resistance becomes insufficient. Therefore, the V content in the TiAl alloy cast material is 0.5 to 2.0 atom %. In order to improve the impact resistance and in order to secure the oxidation resistance, the V content is preferably 0.7 to 1.8 atom % and more preferably 0.9 to 1.6 atom %.

### “Nb”

Nb improves the oxidation resistance when the Al content contained in the TiAl alloy cast material is within the above range. When the Nb content is less than 0.5 atom %, the oxidation resistance is improved but is not sufficiently obtained. In addition, when the Nb content is more than 2.5 atom %, the impact resistance becomes insufficient. Therefore, the Nb content in the TiAl alloy cast material is 0.5 to 2.5 atom %. In order to improve the oxidation resistance and in order to secure the impact resistance, the Nb content is preferably 0.6 to 2.3 atom % and more preferably 1.0 to 2.0 atom %.

### “C”

The TiAl alloy cast material of the present embodiment may further contain 0.6 atom % or less of C. C further improves the high-temperature strength of the TiAl alloy cast material. However, when the C content is more than 0.6 atom %, this is not desirable because the impact resistance decreases. Therefore, when the TiAl alloy cast material of the present embodiment further contains C, the C content is 0.6 atom % or less. The C content is more preferably 0.5 atom % or less and still more preferably 0.32 to 0.40 atom %.

In addition, when the TiAl alloy cast material of the present embodiment further contains C, the C content is preferably 0.2 atom % or more. This is because an effect of improving the high-temperature strength of the TiAl alloy cast material becomes significant. Therefore, when the TiAl alloy cast material of the present embodiment further contains C, the C content is more preferably 0.3 atom % or more and still more preferably 0.32 to 0.40 atom %.

### [Method of Producing TiAl Alloy Cast Material]

Next, a method of producing a TiAl alloy cast material of the present embodiment will be exemplified. In the present embodiment, a case in which an investment casting method is used to produce a TiAl alloy cast material that is a cast product will be described.

In order to produce the TiAl alloy cast material of the present embodiment, raw materials are first prepared. The raw material composition is almost the same as the composition of the TiAl alloy cast material obtained after casting. Therefore, raw materials having a composition corresponding to a desired composition after casting are prepared. That is, in the present embodiment, the raw material composition is adjusted so that the composition of the TiAl alloy cast material obtained after casting contains aluminum (Al): 45.5 to 47.5 atom %, manganese (Mn): 1.0 to 3.0 atom %, iron (Fe): 0.3 to 1.0 atom %, vanadium (V): 0.5 to 2.0 atom %, and niobium (Nb): 0.5 to 2.5 atom %, with the remainder being made up of titanium (Ti) and unavoidable impurities. In addition, as necessary, the raw material composition may be adjusted so that the composition of the TiAl alloy cast material after casting contains 0.6 atom % or less of carbon (C).

The shapes of the elements contained in the raw materials corresponding to the composition after casting are not particularly limited. Some or all of the shapes of the elements in the raw materials may be different. The shapes of the elements in the raw materials may be, for example, a pellet shape, a flake shape, a granular shape, a sponge shape, or a powder shape. In addition, the raw materials may contain, for example, alloy raw materials such as AlV and ferroniobium. In addition, as the raw materials, a master alloy ingot produced by melting raw materials corresponding to the composition after casting may be used.

Next, raw materials corresponding to the composition after casting are fused to form a molten alloy.

When the raw materials are melted, it is preferable to use a crucible. As the crucible, for example, a water-cooled copper crucible that is generally used when a TiAl alloy is melted can be used. In addition, as the crucible, a ceramic crucible may be used. Examples of ceramic crucibles include an yttria crucible and a calcia crucible.

As the method for melting raw materials, any method in which raw materials can be melt to form a molten alloy may be used, and any melting method can be used. As the method for melting raw materials, for example, an induction melting method can be used.

When the induction melting method is used, it is preferable to use, for example, a method in which a crucible containing raw materials is placed in a chamber of a melting furnace, the chamber is evacuated, an inert gas such as argon is then introduced, and the raw materials are melted in an inert gas atmosphere. In addition, when the induction melting method is used, for example, a method in which a crucible containing raw materials is placed in a chamber of a melting furnace, an inert gas such as argon gas is introduced without evacuating the chamber, the atmosphere in the chamber is thus replaced with an inert gas atmosphere, and the raw materials are melted may be used.

Then, the molten alloy is poured into a mold.

As the mold, one having a cavity portion having an inner shape similar to the shape of a TiAl alloy cast material product to be produced and made of a known material can be used. As the mold, for example, a mold made of zirconia ceramic, which is used as a mold in an industrial investment casting method for Ti-based alloys, can be used. When a mold made of zirconia ceramic is used, this is preferable because a TiAl alloy cast material with reduced surface defects can be obtained.

As the method of pouring a molten alloy into a mold, a known method can be used. As the method of pouring a molten alloy into a mold, for example, a suction casting method in which a molten alloy is sucked into a mold may be used. In addition, as the method of pouring a molten alloy into a mold, a centrifugal casting method in which a mold is placed on a rotating table, and the rotating table is rotated to apply a centrifugal force to a molten alloy may be used. When the suction casting method and/or the centrifugal casting method is used, it is possible to reduce the occurrence of defective shapes caused by the formation of a region in the cavity portion of the mold where the molten alloy is not sufficiently filled in and to increase the non-defective product yield. Particularly, when a turbine blade for jet engines having a complex shape is produced as a TiAl alloy cast material product, it is preferable to use the suction casting method and/or the centrifugal casting method.

In addition, as the method of pouring a molten alloy into a mold, a method in which a mold for pouring is preheated to a predetermined temperature and the molten alloy is then poured into the mold may be used. By preheating the mold before pouring, the region in the cavity portion of the mold where the molten alloy is not sufficiently filled is less likely to be formed and poor molten alloy flow is less likely to occur. As a result, the castability is improved, and the non-defective product yield increases, which is preferable.

After the molten alloy is poured into the mold, the mold is cooled by a known method, and a casting product close to the shape of a desired TiAl alloy cast material is produced. Then, the mold is removed from the casting product, and as necessary, machining is performed. Through the above steps, the TiAl alloy cast material of the present embodiment is obtained.

The TiAl alloy cast material of the present embodiment contains predetermined amounts of aluminum (Al), manganese (Mn), iron (Fe), vanadium (V), and niobium (Nb), with the remainder being made up of titanium (Ti) and unavoidable impurities. Therefore, the TiAl alloy cast material of the present embodiment has good castability. Therefore, even when the investment casting method is used for production, it is possible to reduce the occurrence of defective shapes due to poor molten alloy flow caused by the formation of a region in the cavity portion of the mold where the molten alloy is not sufficiently filled and the product can be produced with a high non-defective product yield. In addition, since the TiAl alloy cast material of the present embodiment has the above composition, it has excellent impact resistance, high-temperature strength, and oxidation resistance. Therefore, the TiAl alloy cast material of the present embodiment is suitable as a material for a turbine blade for jet engines.

In addition, when the TiAl alloy cast material of the present embodiment contains 0.6 atom % or less of carbon (C), it has even better high-temperature strength. Therefore, for example, it can be preferably used as a material for a member used at a higher temperature, such as a turbine blade in the former stage in jet engines.

### [Turbine Blade for Jet Engines]

The turbine blade for jet engines of the present embodiment is made of the TiAl alloy cast material of the present embodiment. Therefore, it can be produced with a high yield and has excellent impact resistance, high-temperature strength, and oxidation resistance.

The turbine blade for jet engines of the present embodiment can be produced, for example, using the TiAl alloy cast material of the present embodiment as a raw material, and machining it by a known method as necessary. Therefore, for example, compared to production using a method in which a large rectangular ingot made of a TiAl alloy is machined, the amount of machining is small, and the number of processing steps and the removal volume due to machining can be reduced.

The embodiments of the present invention have been described above in detail, but the above embodiments are only examples of the present invention, and additions, omissions, substitutions and other modifications of the configurations can be made without departing from the spirit and scope of the present invention.

### EXAMPLES

### [Alloy No. 1 to Alloy No. 26]

TiAl alloy cast materials (Alloy No. 1 to Alloy No. 26) having compositions shown in Table 1 or Table 2 that are cast products were produced using the following casting method.

First, raw materials having compositions corresponding to compositions shown in Table 1 or Table 2 were prepared. Specifically, raw materials used were sponge Ti, Al pellets, a Mn flake, an Fe granular, an AlV base alloy granular, a Nb flake, and a TiC alloy powder, each of which was weighed out and mixed so that the composition of the TiAl alloy cast material obtained after casting became the composition shown in Table 1 or Table 2, and the total weight was adjusted to about 500 g.

TABLE 1

| Alloy | Classi- | Component (atom %) | | | | | | |
|---|---|---|---|---|---|---|---|---|
| No. | fication | Ti | Al | Mn | Fe | V | Nb | C |
| 1 | Comparative | Remainder | 45.0 | 2.0 | 0.5 | 1.2 | 1.5 | |
| | alloy | | | | | | | |
| 2 | Invention | Remainder | 45.7 | 2.0 | 0.5 | 1.2 | 1.5 | |
| | alloy | | | | | | | |
| 3 | Invention | Remainder | 46.5 | 2.0 | 0.5 | 1.2 | 1.5 | |
| | alloy | | | | | | | |
| 4 | Invention | Remainder | 47.3 | 2.0 | 0.5 | 1.2 | 1.5 | |
| | alloy | | | | | | | |
| 5 | Comparative | Remainder | 47.8 | 2.0 | 0.5 | 1.2 | 1.5 | |
| | alloy | | | | | | | |
| 6 | Comparative | Remainder | 46.5 | 0.8 | 0.5 | 1.2 | 1.5 | |
| | alloy | | | | | | | |
| 7 | Invention | Remainder | 46.5 | 1.2 | 0.5 | 1.2 | 1.5 | |
| | alloy | | | | | | | |
| 8 | Invention | Remainder | 46.5 | 2.8 | 0.5 | 1.2 | 1.5 | |
| | alloy | | | | | | | |
| 9 | Comparative | Remainder | 46.5 | 3.3 | 0.5 | 1.2 | 1.5 | |
| | alloy | | | | | | | |
| 10 | Comparative | Remainder | 46.5 | 2.0 | 0.2 | 1.2 | 1.5 | |
| | alloy | | | | | | | |
| 11 | Invention | Remainder | 46.5 | 2.0 | 0.4 | 1.2 | 1.5 | |
| | alloy | | | | | | | |
| 12 | Invention | Remainder | 46.5 | 2.0 | 0.8 | 1.2 | 1.5 | |
| | alloy | | | | | | | |
| 13 | Comparative | Remainder | 46.5 | 2.0 | 1.2 | 1.2 | 1.5 | |
| | alloy | | | | | | | |

TABLE 2

| Alloy | Classi- | Component (atom %) | | | | | | |
|---|---|---|---|---|---|---|---|---|
| No. | fication | Ti | Al | Mn | Fe | V | Nb | C |
| 14 | Comparative | Remainder | 46.5 | 2.0 | 0.5 | 0.4 | 1.5 | |
| | alloy | | | | | | | |
| 15 | Invention | Remainder | 46.5 | 2.0 | 0.5 | 0.7 | 1.5 | |
| | alloy | | | | | | | |
| 16 | Invention | Remainder | 46.5 | 2.0 | 0.5 | 1.8 | 1.5 | |
| | alloy | | | | | | | |
| 17 | Comparative | Remainder | 46.5 | 2.0 | 0.5 | 2.2 | 1.5 | |
| | alloy | | | | | | | |
| 18 | Comparative | Remainder | 46.5 | 2.0 | 0.5 | 1.2 | 0.4 | |
| | alloy | | | | | | | |
| 19 | Invention | Remainder | 46.5 | 2.0 | 0.5 | 1.2 | 0.6 | |
| | alloy | | | | | | | |
| 20 | Invention | Remainder | 46.5 | 2.0 | 0.5 | 1.2 | 2.3 | |
| | alloy | | | | | | | |
| 21 | Comparative | Remainder | 46.5 | 2.0 | 0.5 | 1.2 | 2.7 | |
| | alloy | | | | | | | |
| 22 | Invention | Remainder | 46.5 | 2.0 | 0.5 | 1.2 | 1.5 | 0.1 |
| | alloy | | | | | | | |
| 23 | Invention | Remainder | 46.5 | 2.0 | 0.5 | 1.2 | 1.5 | 0.3 |
| | alloy | | | | | | | |
| 24 | Invention | Remainder | 46.5 | 2.0 | 0.5 | 1.2 | 1.5 | 0.4 |
| | alloy | | | | | | | |
| 25 | Invention | Remainder | 46.5 | 2.0 | 0.5 | 1.2 | 1.5 | 0.5 |
| | alloy | | | | | | | |
| 26 | Comparative | Remainder | 46.5 | 2.0 | 0.5 | 1.2 | 1.5 | 0.7 |
| | alloy | | | | | | | |

Next, the raw materials were put into an yttria crucible, and melted using an induction melting method to form a molten alloy. Specifically, the crucible containing the raw materials was placed in a chamber of a melting furnace, and evacuation of the chamber was started. After evacuating to a predetermined degree of vacuum, argon gas was introduced, and the pressure of argon gas was brought to a predetermined value to create an argon atmosphere. Then, the output of the induction power source was gradually increased to a maximum output of 5 kW, and the raw materials were heated and melted. After all the raw materials were melted, the output of the induction power source was reduced to 3.5 kW and held for 3 minutes to obtain a molten alloy.

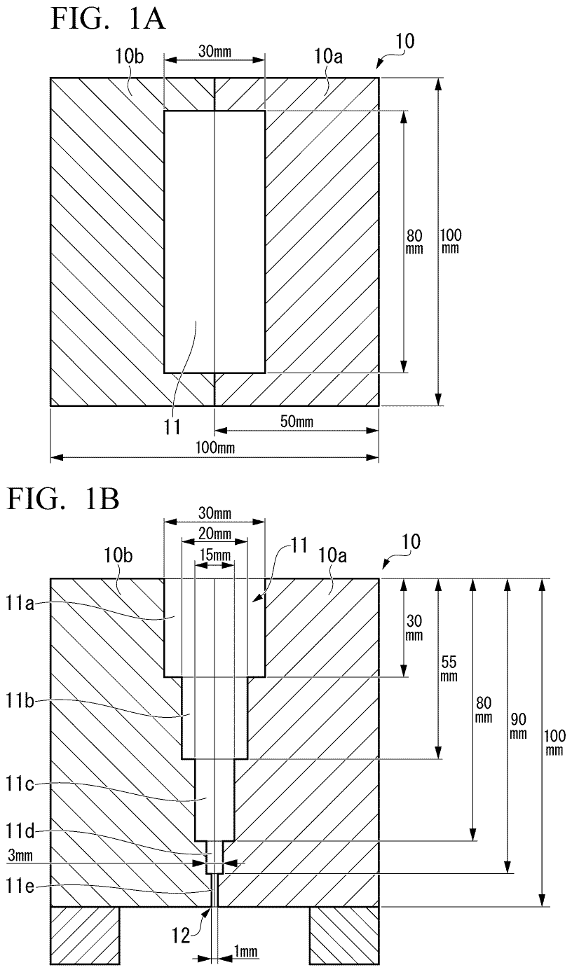

Then, a molten alloy was poured into a mold 10 shown FIG. 1A and FIG. 1B.

FIG. 1A is a schematic view and a plan view showing the mold 10 used in an example. FIG. 1B is a schematic view and a cross-sectional view showing the mold 10 used in an example.

As shown in FIG. 1A and FIG. 1B, a mold 1 shown in FIG. 1A and FIG. 1B has a substantially rectangular parallelepiped outer shape with a side length of 100 mm. The mold 1 includes a first mold 10a and a second mold 10b that is disposed to face the first mold 10a. The first mold 10a and the second mold 10b have substantially the same shape. The first mold 10a and the second mold 10b are made of cast iron.

When a molten alloy is poured into the mold 10, the first mold 10a and the second mold 10b are clamped from the outside with a C-clamp (not shown) and used in an integrated manner. Here, after the molten alloy is cooled to produce TiAl alloy cast materials (Alloy No. 1 to Alloy No. 26), the C-clamp is removed to separate the first mold 10a and the second mold 10b. This allows the TiAl alloy cast materials (Alloy No. 1 to Alloy No. 26) that are casting products to be removed from the mold 10.

In the mold 1, as shown in FIG. 1A and FIG. 1B, the first mold 10a and the second mold 10b are disposed to face each other to form a cavity portion 11. The cavity portion 11 has an inner shape close to the shape of the TiAl alloy cast material produced in an example. The inner surface of the cavity portion 11 is coated with a zirconia-based paint.

As shown in FIG. 1A, the cavity portion 11 is rectangular in a plan view, and the length of a side extending in a first direction is 80 mm. The length of a side extending in a second direction substantially perpendicular to the first direction of the cavity portion 11 in a plan view becomes shorter in a stepwise manner from a pouring gate to a bottom surface as shown in FIG. 1B.

Specifically, as shown in FIG. 1B, the length of the side extending in the second direction of the cavity portion 11 is 30 mm in a first region 11a from the pouring gate to a dimension range of 30 mm or less in the bottom surface direction, 20 mm in a second region 11b from the pouring gate to a dimension range of more than 30 mm and 55 mm or less in the bottom surface direction, 15 mm in a third region 11c from the pouring gate to a dimension range of more than 55 mm and 80 mm or less in the bottom surface direction, and 3 mm in a fourth region 11d from the pouring gate to a dimension range of more than 80 mm and 90 mm or less in the bottom surface direction.

In addition, as shown in FIG. 1B, on the bottom surface of the cavity portion 11, a slit 12 having a length of 80 mm in the first direction and a length of 1 mm in the second direction is provided. The slit 12 is a fifth region 11e from the pouring gate to a dimension range of more than 90 mm and 100 mm or less in the bottom surface direction.

When a molten alloy was poured into the mold 10, an alumina funnel was placed on the cavity portion 11 of the mold 10. The funnel was placed with its inner surface aligned with the pouring gate of the cavity portion 11. The molten alloy was supplied into the cavity portion 11 through the funnel. The molten alloy was supplied until the liquid level of the poured molten alloy reached a position above the pouring gate of the cavity portion 11 on the inner wall of the funnel.

In this manner, the molten alloy was poured into the mold 10 and the mold 10 was then cooled to produce a desired TiAl alloy cast material. Then, the C-clamp was removed to separate the first mold 10a and the second mold 10b, and TiAl alloy cast materials (Alloy No. 1 to Alloy No. 26) that are casting products were removed from the mold 10.

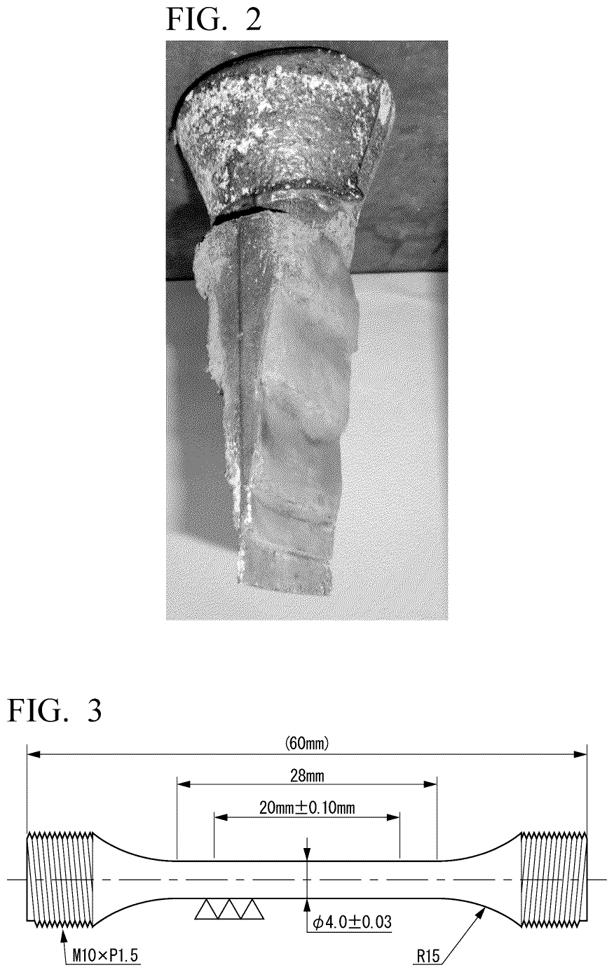

FIG. 2 is an image of an example of the TiAl alloy cast material obtained in an example, and a captured image of Alloy No. 2.

Alloy No. 1 to Alloy No. 26 thus obtained were subjected to chemical analysis using induction inductively coupled plasma (ICP) emission spectrometry and combustion-infrared absorption spectrometry.

As a result, it was confirmed that the compositions of Alloy No. 1 to Alloy No. 26 were all the compositions shown in Table 1 or Table 2.

Next, Alloy No. 1 to Alloy No. 26 thus obtained were evaluated for “(1) castability,” “(2) impact resistance,” “(3) high-temperature strength,” and “(4) oxidation resistance” by the following methods. The results are shown in Table 3 and Table 4.

In addition, Table 1 to Table 4 show Alloy No. 1 to Alloy No. 26, which are classified as “invention alloys” which are examples of the present invention, and “comparative alloys” which are comparative examples.

### (1) Castability

In order to produce Alloy No. 1 to Alloy No. 26, when 500 g of a molten alloy was poured into the mold 10, the amount of leaked molten alloy leaking from the slit 12 provided on the bottom surface of the cavity portion 11 was measured. The results were evaluated based on the following evaluation criteria.

### [Evaluation Criteria]

A (superior castability): when 500 g of the molten alloy was poured, the amount of leaked molten alloy was 40 g or more.
B (excellent castability): when 500 g of the molten alloy was poured, the amount of leaked molten alloy was 20 g or more and less than 40 g.
C (poor castability): when 500 g of the molten alloy was poured, the amount of leaked molten alloy was less than 20 g.

### (2) Impact Resistance

Generally, when turbine blades for jet engines, which were made of TiAl alloy cast materials, were produced, a hot isostatic pressing (HIP) treatment was performed on the TiAl alloy cast materials obtained after casting. Therefore, before evaluating (2) impact resistance, Alloy No. 1 to Alloy No. 26 were subjected to a heat treatment in which the samples were held at 1,200° C. for 4 hours, which corresponds to general HIP conditions, and then cooled at a cooling rate of 10° C./min.

In addition, the TiAl alloy cast material was a brittle material. Therefore, when a V notch with a depth of 2 mm was made in a Charpy impact test specimen made of the TiAl alloy cast material, the measurement result of the absorbed energy became smaller. As a result, there is a risk of the difference in the absorbed energy measurement results between the specimens being small, and the difference in the specimens unable to be evaluated. Therefore, in (2) impact resistance in this example, a flat Charpy impact test piece without a V notch was prepared as a specimen. In addition, as a hammer used in the Charpy impact test, a small hammer with a capacity of 15 J was used in order to reduce the measurement error.

Specifically, in Alloy No. 1 to Alloy No. 26, which were subjected to a heat treatment corresponding to HIP conditions, Charpy impact test pieces were collected from parts (second region 11b) in which the length of the side extending in the second direction in the cavity portion 11 of the mold 1 shown in FIG. 1A and FIG. 1B was 20 mm. As the Charpy impact test piece, flat test pieces with a height of 10 mm, a width of 10 mm, and a length of 55 mm were prepared. Then, the Charpy impact test pieces were subjected to a Charpy impact test at room temperature (20° C.), and the absorbed energy was measured. The results were evaluated based on the following evaluation criteria.

### [Evaluation Criteria]

A (superior impact resistance): the absorbed energy in the Charpy impact test at room temperature (20° C.) was 6 J/cm² or more.
B (excellent impact resistance): the absorbed energy in the Charpy impact test at room temperature (20° C.) was 4 J/cm² or more and less than 6 J/cm².
C (poor impact resistance): the absorbed energy in the Charpy impact test at room temperature (20° C.) was less than 4 J/cm².

### (3) High-Temperature Strength

In Alloy No. 1 to Alloy No. 26 after the Charpy impact test pieces were collected in (2) impact resistance, tensile test pieces were collected from parts (the third region 11c) in which the length of the side extending in the second direction in the cavity portion 11 of the mold 1 shown in FIG. 1A and FIG. 1B was 15 mm. As the tensile test piece, test pieces having a circular cross section with shoulders provided between a parallel portion and grips provided at both ends of the parallel portion were prepared. Specifically, as shown in FIG. 3, a tensile test piece with a total length of 60 mm in which the parallel portion had a cylindrical shape with a diameter of 4 mmt0.03 mm and a length of 28 mm, the distance between marks provided at the center of the parallel portion was 20 mm±0.1 mm, the grip was a screw with an outer diameter of 10 mm and a pitch of 1.5 mm (M10×P1.5), and the shoulder was a curve with a side view radius R of 15 mm was prepared. The tensile test pieces thus obtained were subjected to a tensile test at 800° C., and the tensile strength at break, which is the maximum load, was measured. Then, the results were evaluated based on the following evaluation criteria.

### [Evaluation Criteria]

A (superior high-temperature strength): the tensile strength at 800° C. was 500 MPa or more.
B (excellent high-temperature strength): the tensile strength at 800° C. was 400 MPa or more and less than 500 MPa.
C (poor high-temperature strength): the tensile strength at 800° C. was less than 400 MPa.

### (4) Oxidation Resistance

In Alloy No. 1 to Alloy No. 26 after the tensile test pieces were collected in (3) high-temperature strength, oxidation test pieces were collected from parts (the fourth region 11d) in which the length of the side extending in the second direction in the cavity portion 11 of the mold 1 shown in FIG. 1A and FIG. 1B was 3 mm. As the oxidation test piece, flat test pieces with a height of 10 mm, a width of 20 mm, and a thickness of 2 mm were prepared. The oxidation test pieces were prepared by a method in which, from the fourth region 11d in Alloy No. 1 to Alloy No. 26 after the tensile test piece was collected for the high-temperature strength, flat plates were cut out by a cutting method using a grindstone, and the surfaces of the obtained flat plates were polished with water-resistant abrasive paper having a grit size of 600. The oxidation test pieces thus obtained were subjected to an oxidation test in which the sample was held at 1,000° C. for 100 hours in air, and the oxidation weight increase after the oxidation test was measured. Then, the results were evaluated based on the following evaluation criteria.

### [Evaluation Criteria]

A (superior oxidation resistance): the weight increase after the oxidation test was 0.1 kg/m² or less.
B (excellent oxidation resistance): the weight increase after the oxidation test was more than 0.1 kg/m² and 0.2 kg/m² or less.
C (poor oxidation resistance): the weight increase after the oxidation test was more than 0.2 kg/m².

TABLE 3

| | | Measurement results | | | | | | | |
|---|---|---|---|---|---|---|---|---|---|
| | | | | | Weight | | | | |
| | | | | | increase in | | | | |
| | | | Absorbed | | oxidation | Evaluation | | | |
| | | | energy in | | test at | | Impact | | |
| | | Amount | Charpy at | Tensile | 1,000° C. | | resistance | High- | |
| | | of leaked | room tem- | strength | for 100 h | | at room | temper- | |
| Alloy | Classi- | molten | perature | at 800° C. | in air | Cast- | temper- | ature | Oxidation |
| No. | fication | alloy (g) | (J/cm²) | (MPa) | (kg/m²) | ability | ature | strength | resistance |
| 1 | Comparative | 32.0 | 3.0 | 480 | 0.15 | B | C | B | B |
| | alloy | | | | | | | | |
| 2 | Invention | 28.3 | 4.5 | 462 | 0.17 | B | B | B | B |
| | alloy | | | | | | | | |
| 3 | Invention | 35.4 | 5.6 | 435 | 0.18 | B | B | B | B |
| | alloy | | | | | | | | |
| 4 | Invention | 29.6 | 5.3 | 427 | 0.14 | B | B | B | B |
| | alloy | | | | | | | | |
| 5 | Comparative | 31.2 | 3.4 | 386 | 0.12 | B | C | C | B |
| | alloy | | | | | | | | |
| 6 | Comparative | 18.5 | 4.6 | 485 | 0.13 | C | B | B | B |
| | alloy | | | | | | | | |
| 7 | Invention | 23.5 | 5.2 | 465 | 0.15 | B | B | B | B |
| | alloy | | | | | | | | |
| 8 | Invention | 42.3 | 4.8 | 431 | 0.18 | A | B | B | B |
| | alloy | | | | | | | | |
| 9 | Comparative | 52.7 | 4.5 | 392 | 0.22 | A | B | C | C |
| | alloy | | | | | | | | |
| 10 | Comparative | 17.6 | 5.3 | 491 | 0.12 | C | B | B | B |
| | alloy | | | | | | | | |
| 11 | Invention | 28.6 | 5.5 | 475 | 0.15 | B | B | B | B |
| | alloy | | | | | | | | |
| 12 | Invention | 47.8 | 4.8 | 431 | 0.18 | A | B | B | B |
| | alloy | | | | | | | | |
| 13 | Comparative | 61.4 | 4.5 | 37 | 0.23 | A | B | C | C |
| | alloy | | | | | | | | |

TABLE 4

| | | Measurement results | | | | | | | |
|---|---|---|---|---|---|---|---|---|---|
| | | | | | Weight | | | | |
| | | | | | increase in | | | | |
| | | | Absorbed | | oxidation | Evaluation | | | |
| | | | energy in | | test at | | Impact | | |
| | | Amount | Charpy at | Tensile | 1,000° C. | | resistance | High- | |
| | | of leaked | room tem- | strength | for 100 h | | at room | temper- | |
| Alloy | Classi- | molten | perature | at 800° C. | in air | Cast- | temper- | ature | Oxidation |
| No. | fication | alloy (g) | (J/cm²) | (MPa) | (kg/m²) | ability | ature | strength | resistance |
| 14 | Comparative | 24.3 | 3.7 | 426 | 0.11 | B | C | B | B |
| | alloy | | | | | | | | |
| 15 | Invention | 31.2 | 4.6 | 456 | 0.14 | B | B | B | B |
| | alloy | | | | | | | | |
| 16 | Invention | 34.2 | 6.4 | 486 | 0.19 | B | A | B | B |
| | alloy | | | | | | | | |
| 17 | Comparative | 28.9 | 7.2 | 534 | 0.24 | B | A | A | C |
| | alloy | | | | | | | | |
| 18 | Comparative | 34.2 | 5.7 | 451 | 0.23 | B | B | B | C |
| | alloy | | | | | | | | |
| 19 | Invention | 29.7 | 5.3 | 423 | 0.18 | B | B | B | B |
| | alloy | | | | | | | | |
| 20 | Invention | 26.3 | 4.6 | 476 | 0.09 | B | B | B | A |
| | alloy | | | | | | | | |
| 21 | Comparative | 34.2 | 3.5 | 462 | 0.05 | B | C | B | A |
| | alloy | | | | | | | | |
| 22 | Invention | 34.2 | 5.2 | 482 | 0.15 | B | B | B | B |
| | alloy | | | | | | | | |
| 23 | Invention | 28.9 | 4.8 | 513 | 0.16 | B | B | A | B |
| | alloy | | | | | | | | |
| 24 | Invention | 27.3 | 4.5 | 545 | 0.13 | B | B | A | B |
| | alloy | | | | | | | | |
| 25 | Invention | 34.2 | 4.2 | 578 | 0.14 | B | B | A | B |
| | alloy | | | | | | | | |
| 26 | Comparative | 25.6 | 3.2 | 604 | 0.17 | B | C | A | B |
| | alloy | | | | | | | | |

As shown in Table 3 and Table 4, it was confirmed that Alloys Nos. 2 to 4, 7, 8, 11, 12, 15, 16, 19, and 20 containing aluminum (Al): 45.5 to 47.5 atom %, manganese (Mn): 1.0 to 3.0 atom %, iron (Fe): 0.3 to 1.0 atom %, vanadium (V): 0.5 to 2.0 atom %, and niobium (Nb): 0.5 to 2.5 atom %, with the remainder being made up of titanium (Ti) and unavoidable impurities, which were “invention alloys,” and Alloys Nos. 22 to 25, further containing carbon (C): 0.6 atom % or less, which were “invention alloys,” all had excellent castability, impact resistance, high-temperature strength, and oxidation resistance.

Hereinafter, the present invention will be described in more detail.

### [1] About Suitable Al Concentration

Alloys Nos. 1 to 5 were a group in which the Al content was changed. In this group, the contents of components excluding Al, Ti and irreversible impurities were within appropriate ranges such as manganese (Mn): 2.0 atom %, iron (Fe): 0.5 atom %, vanadium (V): 1.2 atom %, and niobium (Nb): 1.5 atom %.

When the Al content was 45.7 atom % (Alloy No. 2), 46.5 atom % (Alloy No. 3), and 47.3 atom % (Alloy No. 4), the castability, the impact resistance, the high-temperature strength, and the oxidation resistance were all good.

On the other hand, when the Al content was low as 45.0 atom % (Alloy No. 1 (comparative alloy)), the impact resistance was poor. In addition, when the Al content was high as 47.8 atom % (Alloy No. 5 (comparative alloy)), the impact resistance and the high-temperature strength were poor.

### [2] About Suitable Mn Concentration

Alloys Nos. 6 to 9 were a group in which the Mn content was changed. In this group, the contents of components excluding Mn, Ti and irreversible impurities were within appropriate ranges such as aluminum (Al): 46.5 atom %, iron (Fe): 0.5 atom %, vanadium (V): 1.2 atom %, and niobium (Nb): 1.5 atom %.

When the Mn content was 1.2 atom % (Alloy No. 7) and 2.8 atom % (Alloy No. 8), the castability, the impact resistance, the high-temperature strength, and the oxidation resistance were all good. Particularly, Alloy No. 8 had excellent castability.

On the other hand, when the Mn content was low as 0.8 atom % (Alloy No. 6 (comparative alloy)), the castability was poor. In addition, when Mn was high as 3.3 atom % (Alloy No. 9 (comparative alloy)), the castability was particularly excellent, but the high-temperature strength and the oxidation resistance were poor.

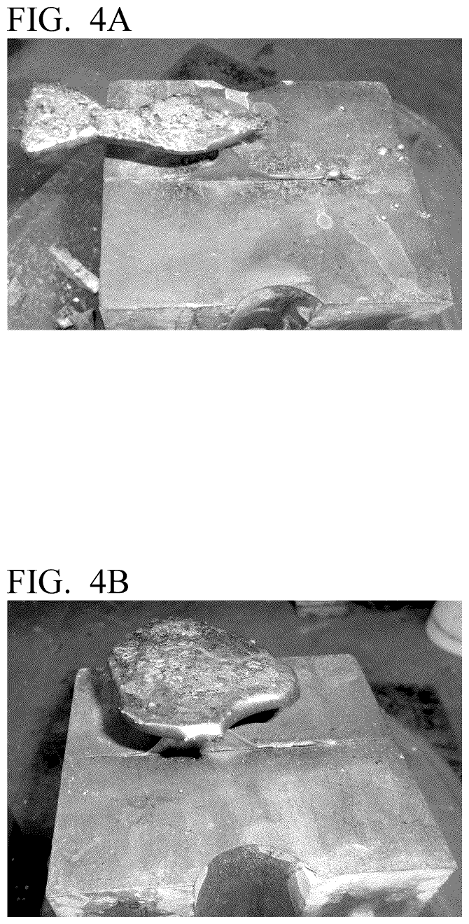

FIG. 4A is an image in which, with Alloy No. 6 (comparative alloy), when the molten alloy was poured into the mold 10, the molten alloy leaking from the slit 12 provided on the bottom surface of the cavity portion 11 was imaged from the outer surface of the mold 10. In addition, FIG. 4B is an image in which, with Alloy No. 8 (invention alloy), when the molten alloy was poured into the mold 10, the molten alloy leaking from the slit 12 provided on the bottom surface of the cavity portion 11 was imaged from the outer surface of the mold 10.

As shown in FIG. 4A and FIG. 4B, it can be understood that the amount of leaked molten alloy leaking from the slit 12 was larger with Alloy No. 8 (invention alloy) than Alloy No. 6 (comparative alloy). The amount of leaked molten alloy leaking from the slit 12 provided on the bottom surface of the cavity portion 11 was naturally closely related to the fluidity of the molten alloy. That is, when the amount of molten alloy leaking from the slit 12 was larger, it could be evaluated that the fluidity of the molten alloy was better, and the castability was better.

### [3] About Suitable Fe Concentration

Alloys Nos. 10 to 13 were a group in which the Fe content was changed. In this group, the contents of components excluding Fe, Ti and irreversible impurities were within appropriate ranges such as aluminum (Al): 46.5 atom %, manganese (Mn): 2.0 atom %, vanadium (V): 1.2 atom %, and niobium (Nb): 1.5 atom %.

When the Fe content was 0.4 atom % (Alloy No. 11) and 0.8 atom % (Alloy No. 12), the castability, the impact resistance, the high-temperature strength, and the oxidation resistance were all good. Particularly, Alloy No. 12 had excellent castability.

On the other hand, when the Fe content was low as 0.2 atom % (Alloy No. 10 (comparative alloy)), the castability was poor. In addition, when the Fe content was high as 1.2 atom % (Alloy No. 13 (comparative alloy)), the castability was particularly excellent, but the high-temperature strength and the oxidation resistance were poor.

### [4] About Suitable V Concentration

Alloys Nos. 14 to 17 were a group in which the V content was changed. In this group, the contents of components excluding V, Ti and irreversible impurities were appropriate ranges such as aluminum (Al): 46.5 atom %, manganese (Mn): 2.0 atom %, iron (Fe): 0.5 atom %, and niobium (Nb): 1.5 atom %.

When the V content was 0.7 atom % (Alloy No. 15) and 1.8 atom % (Alloy No. 16), the castability, the impact resistance, the high-temperature strength, and the oxidation resistance were all good. Particularly, Alloy No. 16 had excellent impact resistance.

On the other hand, when the V content was low as 0.4 atom % (Alloy No. 14 (comparative alloy)), the impact resistance was poor. In addition, when the V content was high as 2.2 atom % (Alloy No. 17 (comparative alloy)), the impact resistance and the high-temperature strength were particularly excellent, but the oxidation resistance was poor.

### [5] About Suitable Nb Concentration

Alloys Nos. 18 to 21 were a group in which the Nb content was changed. In this group, the contents of components excluding Nb, Ti and irreversible impurities were appropriate ranges such as aluminum (Al): 46.5 atom %, manganese (Mn): 2.0 atom %, iron (Fe): 0.5 atom %, and vanadium (V): 1.2 atom %.

When the Nb content was 0.6 atom % (Alloy No. 19) and 2.3 atom % (Alloy No. 20), the castability, the impact resistance, the high-temperature strength, and the oxidation resistance were all good. Particularly, Alloy No. 20 had excellent oxidation resistance.

On the other hand, when the Nb content was low as 0.4 atom % (Alloy No. 18 (comparative alloy)), the oxidation resistance was poor. In addition, when the Nb content was high as 2.7 atom % (Alloy No. 21 (comparative alloy)), the oxidation resistance was particularly excellent, but the impact resistance was poor.

### [6] About Suitable C Concentration

Alloys Nos. 22 to 26 were a group in which the content of C additionally added was changed. In this group, the contents of components excluding C, Ti and irreversible impurities were within appropriate ranges such as aluminum (Al): 46.5 atom %, manganese (Mn): 2.0 atom %, iron (Fe): 0.5 atom %, vanadium (V): 1.2 atom %, and niobium (Nb): 1.5 atom %.

When the C content was 0.3 atom % (Alloy No. 23), 0.4 atom % (Alloy No. 24), and 0.5 atom % (Alloy No. 25), the castability, the impact resistance, and the oxidation resistance were all good, and the high-temperature strength was particularly excellent.

On the other hand, when the C content was relatively low as 0.1 atom % (Alloy No. 22), the castability, the impact resistance, the high-temperature strength, and the oxidation resistance were all good, but the high-temperature strength was not particularly excellent.

In addition, when the C content was high as 0.7 atom % (Alloy No. 26 (comparative alloy)), the high-temperature strength was significantly excellent, but the impact resistance was poor.

### [7] Summary

As described above, the “invention alloys” shown in Table 1 to Table 4 exhibited better properties compared to the “comparative alloys” which did not satisfy the composition of the TiAl alloy cast material according to the present application.

In addition, among the “invention alloys” shown in Table 1 to Table 4, in the “invention alloy” further containing 0.2 to 0.6 atom % of carbon (C), the castability, the impact resistance, and the oxidation resistance were all good, and the high-temperature strength was also superior.

### INDUSTRIAL APPLICABILITY

The TiAl alloy cast material of the present invention has good castability. Therefore, even when the investment casting method is used for production, it is possible to reduce the occurrence of defective shapes due to poor molten alloy flow caused by the formation of a region in the cavity portion of the mold where the molten alloy is not sufficiently filled and the product can be produced with a high non-defective product yield. In addition, the TiAl alloy cast material of the present invention has excellent the impact resistance. Therefore, for example, even if it is used for a member with which a foreign object collides during use such as a turbine blade for jet engines, it is unlikely to break due to impact. Moreover, the TiAl alloy cast material of the present invention has excellent high-temperature strength and oxidation resistance. Therefore, for example, it can be suitably used as a member used at a higher temperature such as a turbine blade for jet engines.

As described above, the TiAl alloy cast material of the present invention can be preferably used as a material for a turbine blade for jet engines such as the last stage turbine blade for jet engines.

In addition, when the TiAl alloy cast material of the present invention contains 0.6 atom % or less of carbon (C), it has even better high-temperature strength. Therefore, for example, it can be preferably used as a material for a member used at a higher temperature, such as a turbine blade in the former stage in jet engines.

### REFERENCE SIGNS LIST

1 Mold
   10a First mold
   10b Second mold
   11 Cavity portion
   12 Slit

1. A TiAl alloy material, comprising
aluminum: 45.5 to 47.5 atom %,
manganese: 1.0 to 3.0 atom %,
iron: 0.3 to 1.0 atom %,
vanadium: 0.5 to 2.0 atom %, and
niobium: 0.5 to 2.5 atom %,
a titanium and unavoidable impurities balance containing inevitable impurities.

2. The TiAl alloy material according to claim 1, further comprising carbon: 0.6 atom % or less.

3. The TiAl alloy material according to claim 2, further comprising carbon: 0.2 atom % or more.

4. The TiAl alloy material according to claim 1,
wherein a content of aluminum is 46.0 to 47.0 atom %.

5. The TiAl alloy material according to claim 1,
wherein a content of manganese is 1.2 to 2.8 atom %.

6. The TiAl alloy material according to claim 1,
wherein a content of iron is 0.4 to 0.8 atom %.

7. The TiAl alloy material according to claim 1,
wherein a content of vanadium is 0.7 to 1.8 atom %.

8. The TiAl alloy material according to claim 1,
wherein a content of niobium is 0.6 to 2.3 atom %.

9. The TiAl alloy material according to claim 3,
wherein a content of carbon is 0.3 to 0.5 atom %.

10. The TiAl alloy material according to claim 1,
wherein, an amount of leaked molten alloy leaking from the slit is 20 g or more, in a case where 500 g of a molten alloy obtained by melting raw materials corresponding to a composition after casting is poured from a pouring gate, and
wherein, in a mold having a rectangular cavity portion in a plan view, the cavity portion having a side extending in a first direction that is 80 mm in length and a side extending in a second direction that becomes shorter in length in a stepwise manner from the pouring gate to a bottom surface, and a slit is provided on the bottom surface, length of the slit in the first direction and the second direction is 80 mm and 1 mm, respectively.

11. The TiAl alloy material according to claim 1,
wherein a absorbed energy in a Charpy impact test at 20° C. is 4 J/cm² or more.

12. The TiAl alloy material according to claim 1,
wherein a tensile strength at 800° C. is 400 MPa or more.

13. The TiAl alloy material according to claim 1,
wherein a weight increase when the surface is polished with water-resistant abrasive paper having a grit size of 600 and then held at 1,000° C. for 100 hours in air is 0.2 kg/m² or less.

14. A rotor blade for jet engines made of the TiAl alloy material according to claim 1.
